(19) United States
(12) Patent Application Publication
(10) Pub. No.: US 2010/0141142 A1
(43) Pub. Date: Jun. 10, 2010

(54) DISCHARGE LAMP

(75) Inventors: Masanori MATOBA, Himeji-shi (JP); Tsuneo OKANUMA, Himeji-shi (JP)

Correspondence Address: ROBERTS MLOTKOWSKI SAFRAN & COLE, P.C.;Intellectual Property Department, P.O. Box 10064, MCLEAN, VA, 22102-8064, US

(73) Assignee: USHIO DENKI KABUSHIKI KAISHA, Tokyo (JP)

(21) Appl. No.: 12/620,124

(22) Filed: Nov. 17, 2009

(30) Foreign Application Priority Data
Dec. 4, 2008 (JP) 2008-309244

(51) Int. Cl. H01J 61/36

(52) U.S. Cl. 313/623

(57) ABSTRACT

To provide a discharge lamp capable of joining metal plates together with leads respectively using a filler material by matching the center of the metal plates to the axial center of the leads a discharge lamp having a metal plate (61, 62) disposed on the end face of a glass member (11), a metal foil provided on the outer peripheral surface of the glass member (11) and connected to the metal plates, and a lead (8) extending toward the outside of a discharge vessel (1), wherein the metal plate (61, 62) has a tapered through-hole (63); the lead (5, 8) provided with a tapered section (53, 58) is inserted into the tapered through-hole (63); and the tapered through-hole (63) is joined together with the tapered section (53, 83) using a filler material (9).

### BACKGROUND OF THE INVENTION

1. Field of the Invention

The present invention relates to a discharge lamp, particularly to a short arc type discharge lamp used as a light source for projection aligners, photochemical reactors and the like.

2. Description of Related Art

A wide variety of discharge lamps have conventionally been known. Among them, a discharge lamp having mercury sealed inside an arc tube has been used as a light source for alignment in the light exposure treatment of semiconductor wafers and liquid crystal substrates because it has the illumination characteristics of emitting an i-line having a wavelength of 365 nm and a g-line having a wavelength of 436 nm.

In a discharge lamp for a high current, a large amount of mercury is sealed inside as the major component of emission gas, the pressure inside the arc tube becomes high during operation, and the amount of heat is large. Accordingly, heat resistance and pressure resistance are required, particularly on the side tubes and glass inside the side tubes. In addition, mercury inside the arc tube needs to be completely evaporated during operation. Therefore, it is necessary not to have any section, which is so low in temperature that mercury is condensed, inside the arc tube during operation.

For this reason, a foil-seal structure, which uses a metal foil for sealing, is used in discharge lamps for a high current rather than a rod-seal structure, the rod-seal structure achieving the airtight sealing of the are tube by directly welding glass, which forms the arc tube, to a lead for supplying power. Since a high current is supplied to the electrodes, the current flowing in the metal foils and the members connecting the metal foils to the electrodes is also high. Accordingly, a disc-shaped metal plate is used as a member connecting the metal foil to the electrode.

FIG. 4 is an explanatory partial view showing a discharge lamp having a foil-seal structure.

As disclosed in Published Unexamined Japanese Patent Application No. 2007-115498, a discharge lamp has a discharge vessel 1, wherein a sealing tube 3 is provided in a continuous arrangement on each of opposite sides of an arc tube 2. Inside the arc tube 2 a pair of opposed electrodes 4 is arranged. Inside the sealing parts 3 are disposed a glass member 11, a metal foil 7, metal plates 61, 62, an electrode support rod 5, an outer lead 8 and a glass cylinder 12 for holding the electrode support rod 5, all of which not only hold the electrodes 4 disposed inside the arc tube 2, but also allow electrical connection of the electrodes 4 to an external power source.

On the outer peripheral surface of the cylindrical glass member 11, multiple sheets of belt-shaped metal foils 7 are disposed in a manner of extending in the axial direction and spaced from each other in a circumferential direction, wherein the number of sheets is five, for example. The tip ends of these metal foils 7 are connected to the metal plate 61, the metal plate 61 being disposed in a manner having the electrode support rod inserted therein. On the other hand, the rear ends of the metal foils 7 are connected to the metal plate 62 into which the outer lead 8 is inserted. On the rear end of the glass member 11 is disposed, via the metal plate 62, a second glass cylinder 12 which holds the outer lead 8.

The electrode support rod 5 and the metal plate 61 are joined together using a filler material in a manner producing a contact area sufficient to efficiently transmit power supplied to the metal plate 61 to the electrode support rod 5. Similarly, the outer lead 8 and the metal plate 62 are also connected to each other. The filler material needs to be resistant to a glass processing temperature (about 1600° C.), highly wettable not only with tungsten (W), which forms the electrode support rod 5 and the outer lead 8, but also with molybdenum (Mo), which forms the metal plates 61, 62, low in vapor pressure and unreactive with other sealed materials. The filler materials that can be used include zirconium (Zr), platinum (Pt), and rhodium (Rh), which satisfy the abovementioned requirements.

FIG. 5 is an enlarged sectional view showing an enlarged joint section between the metal plate 61 and the electrode support rod 5.

Since tungsten (W), the material for the electrode support rod 5, and molybdenum (Mo), the material for the metal plate 61, are hard to cut, a certain tolerance is given to the axial diameter of the electrode support rod 5 and the diameter of the through-hole 63. Therefore, there is some allowance for joining them together. Accordingly, if a filler material 9 is non-uniformly put between the electrode support rod 5 and the metal plate 61 and solidified, the metal plate will be shifted such that the center of the metal plate 61 becomes out of sync with the axial center of the electrode support rod 5.

If the center of the metal plate 61 shifts, the outer peripheral surface of the glass member 11 cannot smoothly be connected to the outer ring of the metal plate 61, making a certain level difference. Excess force may be applied to the metal foil 7, which is extended on the outer peripheral surface of the glass member 11 in the axial direction to be connected to the outer ring of the metal plate 61, due to the level difference. As a result, the metal foil 7 becomes liable to be cut off.

### SUMMARY OF THE INVENTION

The present invention was made to solve the abovementioned problems. Thus, a primary object of the present invention is to provide a discharge lamp in which a metal plate, together with a lead, are joined using a filler material with the center of the metal plate matched to the axial center of the lead.

A first aspect of the present application relates to a discharge lamp comprising: a discharge vessel having an arc tube and sealing tubes, the sealing tubes extending continuously from both ends of the arc tube in an outward direction; a glass member disposed inside of at least one of the sealing tubes; metal plates continuously disposed on the end surfaces of the glass member, metal foils provided on the outer peripheral surface of the glass member and connected to the metal plates; outer leads extending toward the outside of the discharge vessel; and electrodes formed on tip ends of electrode leads extending toward the arc tube, the electrodes being disposed inside the arc tube in a manner of facing each other, wherein at least one of the metal plates has a tapered through-hole; wherein at least one of the leads is provided with a tapered section arranged in the tapered through-hole; and wherein the tapered through-hole and the tapered section are joined together using a filler material.

A second aspect of the present application relates to the first aspect of the present application, wherein a recess is formed on the through-hole of the metal plate by expanding one end face of the through-hole, the recess receiving a filler material reservoir section where a gap between the through-hole and the lead is widened.

A third aspect of the present application relates to the first aspect of the present application, wherein a recess is formed by making a dent on the lead, the recess providing a filler material reservoir section.

The fourth aspect of the present application relates to the first aspect of the present application, wherein the taper angle of the through-hole of the metal plate is at least 1° and not more than 30°.

The fifth aspect of the present application relates to the first aspect of the present application, wherein the taper angle of the tapered section of the lead is at least 1° and not more than 30°.

The discharge lamp according to the first aspect of the present application allows matching of the central axis of the metal plate to the central axis of the lead by inserting the lead having a tapered section into a tapered through-hole, thereby joining them together. Since the gap between the through-hole of the metal plate and the outer peripheral surface of the lead is small, the filler material flows into the narrow area and is solidified uniformly, thus suppressing shifting of the central axes that might otherwise be caused by the infusion of the filler material.

Since the central axis of the metal plate can be matched to the central axis of the lead, the outer peripheral surface of the glass member can smoothly be connected to the outer ring of the metal plate without creating any level difference. No excess force is therefore applied to the metal foil, which is extended on the outer peripheral surface of the glass member in the axial direction to be connected to the outer ring of the metal plate, because there is no level difference, thus preventing the metal foil from being cut off.

In the discharge lamp according to the second and third aspects, the size of the gap is constant and small because the through-hole and the lead are joined together. Since the necessary amount of filler material is small, however, the amount of the filler material to fill the gap may become insufficient if the filler material attaches to the lead more than expected. Therefore, a concavity is provided on the metal plate or the lead in order to form a filler material reservoir section and provide an amount of the filler material that is more than required for the size of the gap. Accordingly, the gap can be filled with a sufficient amount of filler material. As a result, any potential defective welding caused by a shortage of the filler material can be avoided. In addition, an excess amount of filler material is stored in the filler material reservoir section so that no leakage can occur.

In the discharge lamp according to the fourth and fifth aspects, any deviation of the position of attachment can be adjusted in the axial direction of the lead by making the taper angle of the tapered section in the through-hole of the metal plate or the lead at least 1°. It was also found that the metal plate joined together and fixed with the lead such that the metal plate can hardly be tilted at the time of bonding using a filler material can be achieved by making the taper angle of the tapered section at most 30°.

A detailed description of embodiments according to the present invention is given below with reference to the accompanying drawings.

### BRIEF DESCRIPTION OF DRAWINGS

FIG. 1 is a schematic explanatory sectional view showing the configuration of the discharge lamp according to one embodiment of the present invention.

FIG. 2 is a schematic enlarged sectional view showing an enlarged joint portion between a metal plate and an electrode support rod according to the present invention.

FIG. 3 is a schematic sectional view explaining the shape of a filler material reservoir section according to the present invention.

FIG. 4 is a schematic explanatory view showing a part of a conventional discharge lamp having a foil seal structure.

FIG. 5 is a schematic enlarged sectional view showing an enlarged conventional joint portion between a metal plate and an electrode lead.

### DETAILED DESCRIPTION OF THE INVENTION

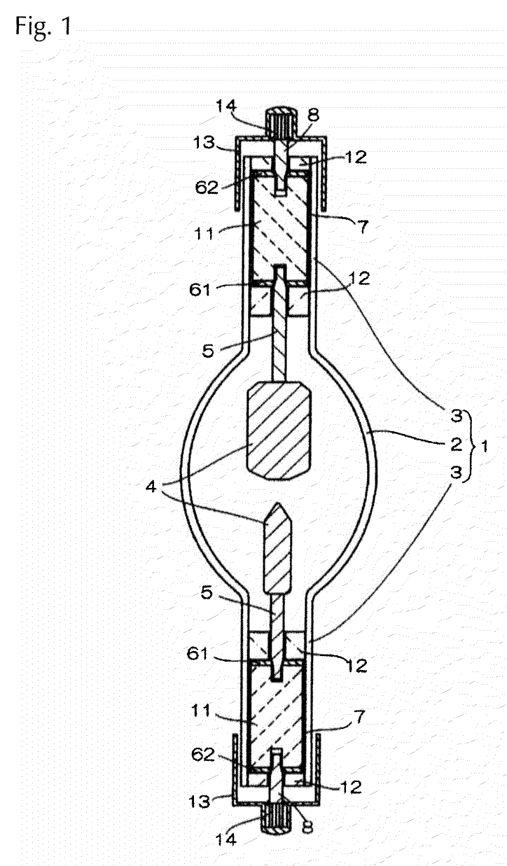

FIG. 1 is an explanatory sectional view showing the configuration of the discharge lamp according to one embodiment of the present invention.

The discharge lamp is made of a light-transparent material, such as quartz glass, and is provided with a discharge vessel 1 having a substantially spherical arc tube 2 and sealing tubes 3 continuously extending outwardly from opposite ends of the are tube 2. Inside of the discharge vessel 1 is a pair of opposed electrodes 4 made of tungsten (W), for example, extending in the direction of the tube axis of the discharge vessel 1. In the inner space of the discharge vessel 1, prescribed amounts of mercury as an emission material and a starting aid gas and a buffer gas are sealed. The buffer gas may be xenon gas, for example. The amount of mercury to be provided may be in the range of 1 to 70 mg/cm³ (e.g., 22 mg/cm³), for example. The amount of xenon gas to be utilized may be in the range of 0.05 to 0.5 MPa (e.g., 0.1 MPa), for example.

Inside the discharge vessel 1, an electrode support rod 5 with an electrode 4 fixed on its tip end is provided within a sealing tube 3 in a manner of extending along its tube axis. The electrode 4 is made of a metal having a high melting point. Specifically, it is made of a metal such as tungsten (W), rhenium (Re) or tantalum (Ta) having a melting point of at least 3000° C. Among these metals, tungsten (W) is particularly preferable. The electrode support rod 5 is integrally connected to the electrode 4 and is made of the same material (metal) as that of the electrode 4, such as tungsten (W), rhenium (Re) or tantalum (Ta).

The other end of the electrode support rod 5 is bonded to a disc-shaped metal plate 61 made of molybdenum (Mo), for example, which is provided within the sealing tube 3, and is inserted into a glass member 11. The disc-shaped metal plate 61 is disposed on one end of the glass member 11 and a disc-shaped metal plate 62 is disposed on the opposite end of the glass member 11. The other metal plate 62 is bonded to one end of outer lead 8. The outer lead 8 extends outside of the discharge vessel 1. In other words, it protrudes out of the outer end of the sealing tube 3.

On the outer peripheral surface of the glass member 11, multiple sheets (e.g., five sheets) of belt-shaped metal foils 7 are provided in the direction of the tube axis of the discharge lamp, the metal foils being spaced from each other in the circumferential direction and running parallel to each other. One end of each metal foil 7 is connected to the metal plate 61 with which the electrode support rod 5 is bonded and the other end thereof connected to the other metal plate 62 with which the outer lead 8 is bonded. The sealing tube 3 of the discharge vessel 1 is welded to the glass member 11 via the metal foils 7 to form an airtight seal structure. A cylindrical supporting member 12 made of quartz glass, for example, is used for supporting the electrode support rod 5 or the outer lead 8 penetrating therethrough and is welded to the sealing tube 3 of the discharge vessel 1.

A base member 13 is attached on each end of the discharge lamp. Power can be supplied to the electrodes 4 by connecting a stranded wire 14 to the outer leads 8, which extend out of the discharge vessel 1, as well as to the base member 13. The stranded wire 14 is made by bundling and then twining metal wires made of copper, and therefore, is flexible to some degree. The positional relationship between the sealing tube 3 and the base member 13 can therefore be adjusted where the outer lead 8 and the stranded wire 14 are bonded together.

In this discharge lamp, the electric breakdown occurs between the electrodes 4 by applying a high voltage (e.g., 20 kV) between the electrodes 4 using a lighting power source (not shown here). Subsequently, a discharge arc is formed to emit light containing an i-line having a wavelength of 365 nm and a g-line having a wavelength of 436 nm.

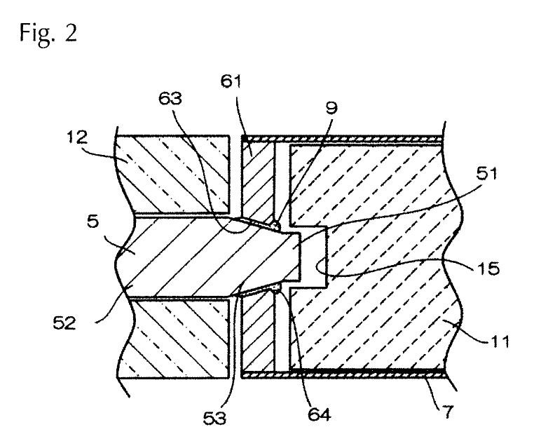

FIG. 2 is a sectional view explaining the configuration of the metal plate 61 and the electrode support rod 5, both of which are disposed on the arc tube side of the discharge lamp.

The metal plate 61 disposed on one end of the glass member 11 is disc-shaped with a through-hole 63 at its center. The distal end of the electrode support rod 5 is inserted into the through-hole 63 formed at the center of the metal plate 61 and further into a blind hole 15 provided on one end of the glass member 11.

The section of the electrode support rod 5 inserted into the glass member 11 constitutes a small diameter section 51, which is smaller in diameter than the other section. The section on the electrode side away from the metal plate 61 constitutes a large diameter section 52. Between the small diameter section 51 and the large diameter section 52 is a tapered section 53 where a tapered surface is formed, the tapered surface gradually reducing its diameter from the large diameter section 52 toward the small diameter section 51. The metal plate 61 is joined together with the circumference of the tapered section 53.

In the through-hole 63 formed at the center of the metal plate 61, the diameter of the opening on one end surface is smaller than the diameter of the opening formed on the other end surface. The through-hole is a tapered hole, wherein the diameter of the hole increases from one end to the other. The tapered through-hole 53 can be formed by taper reamer processing, for example. The slope of the tapered surface on the tapered section 53 of the electrode support rod 5 substantially agrees with the slope of the tapered through-hole 63 of the metal plate 61, and the electrode support rod 5 is penetrated into the metal plate 61 so that the tapered section 53 and the through-hole 63 can be joined together.

The other metal plate 62 and the outer lead 8, both of which are disposed on the outer side of the discharge vessel 1 and not shown here, have the same configuration. One end of the outer lead 8 is inserted into the through-hole 63 formed at the center of the metal plate 62 and further into a closed-end hole 15 provided on the distal side of the glass member 11. The section of the outer lead 8 inserted into the glass member 11 constitutes a small diameter section 81. The small diameter section 81 is followed by a tapered section 83 and a large diameter section 82. The through-hole 63 of the metal plate 62 is also a tapered hole corresponding to the tapered section 83. The outer lead 8 is penetrated into the metal plate 62 so that the tapered section 83 and the through-hole 63 can be joined together.

Since the relationship between the outer lead 8 and the metal plate 62 is the same as that of the electrode support rod 5 and the metal plate 61, the leads 5, 8 are inserted into each through-hole 63 of the metal plates 61, 62 disposed on both ends of the glass member 11, respectively. As used herein, the term “lead” refers to the electrode support rod 5 and the outer lead 8.

Since the leads 5, 8 have a tapered section 53, 83, the outer periphery of which has a tapered surface, which is inserted into and joined together with the through-hole 63, which is a tapered hole of the metal plate 61, 62, the gap between the through-hole 63 and the leads 5, 8 is small compared with the case in which two cylindrical surfaces are joined together. Moreover, the central axis of the tapered through-hole 63 of the metal plates 61, 62 agrees with the central axis of the tapered surface of the tapered sections 53, 83 of the leads 5, 8 by joining the tapered hole and the tapered surface together. Accordingly, the central axis of the metal plates 61, 62 and the central axis of the leads 5, 8 can be matched by forming the tapered hole and the tapered surface with precision.

As described above, the joint surface has a tapered shape in both cases, i.e., the relationship between the outer lead 8 and the metal plate 62 and the relationship between the electrode support rod 5 and the metal plate 61. However, the cylindrical surfaces may be joined together in the relationship between the electrode support rod 5 and the metal plate 61 while the tapered surfaces are joined together in the relationship between the outer lead 8 and the metal plate 62. In other words, the constitution may be such that only either one of the relationship between the outer lead 8 and the metal plate 62 and the relationship between the electrode support rod 5 and the metal plate 61 has tapered surfaces for the joint section. As for the relationship between the metal plates 61, 62 and the leads 5, 8, the occurrence of the severance of the metal foil 7 can be suppressed compared with a conventional discharge lamp only by making the joint surface of either relationship (e.g., the metal plate 62 and the lead 8) taper-shaped.

Moreover, as described above, the section inserted into the glass member 11 constitutes a small diameter section 51, 81, and a tapered section 53, 83 is formed on the lead 5, 8. However, it may be possible to make the section inserted into the glass member 11 a large diameter section, the section to be joined together with the metal plate 61, 62 a tapered section, and the other section a small diameter section. In this case, however, the small diameter section must be provided for a large portion of the rod, which may require a lot of time in the processing work at a time when the small diameter section is formed by shaping the rod-shaped member by a lathing process.

A method for bonding the metal plates 61, 62 and the leads 5, 8 together is described below.

The electrode support rod 5 and the metal plate 61 are bonded together using a filler material 9. The electrode support rod 5 and the filler material 9 are attached closely together. The metal plate 61 and the filler material 9 are also attached closely together. The contact area is secured via the filler material 9, and therefore, the power supplied to the metal plate 61 can be transmitted to the electrode support rod 5 efficiently. Similarly, the outer lead 8 and the metal plate 62 are also connected with each other with the filler material 9. The filler material 9 needs to be resistant to the glass processing temperature (about 1600° C.), highly wettable not only with tungsten (W), which forms the leads 5, 8, but also with molybdenum (Mo), which forms the metal plates 61, 62, low in vapor pressure and unreactive with other sealed materials. Filler materials 9 that can be used include zirconium (Zr), platinum (Pt), and rhodium (Rh), which satisfy the abovementioned requirements.

On the through-hole 63 of the metal plate 61, 62, a concavity 64 is formed by widening the end surface having an opening of a small diameter, whereby the gap between the through-hole 63 of the metal plate 61 and the electrode support rod 5 as well as a gap between the metal plate 62 and the outer lead 8 is widened. The section where the concavity 64 of the through-hole 63 is formed functions as a filler material reservoir section where the filler material 9, which is liquid, is stored, thereby preventing the filler material 9 from leaking out.

The filler material 9 is injected into a gap between the through-hole 63 of the metal plate 61, 62 and the outer peripheral surface of the lead 5, 8 by the following method.

The lead 5, 8 is passed through the through-hole 63 of the metal plate 61, 62, thereby joining them together in advance. In this state of the metal plate 61, 62 and the lead 5, 8, a metal wire made of platinum (Pt) is wound around the section corresponding to the concavity 64 of the lead 5, 8. It is then put in a vacuum furnace or a furnace filled with an inert gas and heated at 1800° C. for 5 minutes. Although neither the tungsten (W) of the lead 5, 8 nor molybdenum (Mo) of the metal plate 61, 62 are melted because their melting points are higher than 1800° C., platinum (Pt) is melted because its melting point is about 1800° C. The molten platinum (Pt) flows into the gap between the through-hole 63 and the lead 5, 8.

As a result, the filler material 9 made of platinum (Pt) fills in the gap between the through-hole 63 and the lead 5, 8. On the other hand, the concavity 64 provided on one end surface of the metal plate 61, 62 can store platinum (Pt) that is left over without being used for filling in the gap between the through-hole 63 and the lead 5, 8, thereby preventing the liquefied platinum (Pt) from leaking out. After cooling, the filler material 9 stored in the concavity 64 is solidified in that place, the filler material reservoir section.

Since the gap between the through-hole 63 of the metal plate 61, 62 and the outer peripheral surface of the lead 5, 8 is small, the amount of platinum (Pt) to be used, which is the starting material for the filler material 9 and expensive, can be reduced. The size of the gap between the through-hole 63 and the lead 5, 8 is constant, and the necessary amount of the filler material 9 is therefore constant. Since the necessary amount of the filler material 9 is small, however, the amount of the filler material to fill the gap may become insufficient if the filler material 9 attaches to the lead 5, 8 more than expected. Therefore, the concavity 64 is provided on one end surface of the metal plate 61, 62 in order to form a filler material reservoir section and provide an amount of filler material 9 more than required for the size of the gap. Accordingly, the gap can be filled with the sufficient amount of filler material 9. As a result, any potential defective welding caused by a shortage of the filler material 9 can be avoided. In addition, an excess amount of filler material 9 is stored in a filler material reservoir section so that no leakage can occur.

As described above, the central axis of the metal plate 61, 62 can be matched to the central axis of the lead 5, 8 by inserting the lead 5, 8 having the tapered section 53, 83, whose outer periphery has a tapered surface, into the through-hole 63, which is the tapered hole of the metal plate 61, 62, thereby joining them together. Moreover, since the gap between the through-hole 63 of the metal plate 61, 62 and the outer peripheral surface of the lead 5, 8 is small, the filler material 9 flows into the narrow area and is solidified uniformly, thus suppressing the shift of the central axis that might otherwise be caused by the infusion of the filler material 9.

Since the central axis of the metal plate 61, 62 can be matched to the central axis of the lead 5, 8, the outer peripheral surface of the glass member 11 can smoothly be connected to the outer ring of the metal plate 61, 62 without creating any level difference. No excess force is therefore applied to the metal foil 7, which is extended on the outer peripheral surface of the glass member 11 in the axial direction to be connected to the outer ring of the metal plate 61, 62, because there is no level difference, thus preventing the metal foil 7 from being cut off.

Moreover, since the central axis of the electrode support rod 5 agrees with the central axis of the metal plate 61 and the central axis of the metal plate 61 with the central axis of the sealing tube 3, the axis of the electrode 4 formed on the tip end of the electrode support rod 5 can be matched to the axis of the discharge vessel 1. With no deviation of the axes of the electrodes 4 that are disposed in a manner of facing each other, non-uniformity of illumination hardly occurs during operation, and the arc is likely to be stabilized, whereby the life span of the discharge lamp can be extended.

The central axis of the metal plate 61, 62 can easily be matched to the central axis of the lead 5, 8 by joining the lead 5, 8, whose outer periphery has a tapered surface, together with the tapered through-hole 63. Nevertheless, the positional accuracy may decline in the axial direction due to the relationship between the accuracy of the diameter of the through-hole 63 of the metal plate 61, 62 and the accuracy of the axial diameter of the lead 5, 8. However, this is not a problem in this invention because the distal end of the outer lead 8 is connected to the stranded wire 14 disposed inside the end piece 13 as shown in FIG. 1, whereby a minute shift in the axial direction can be absorbed by the stranded wire 14.

A description of varying shapes of the filler material reservoir section is given below.

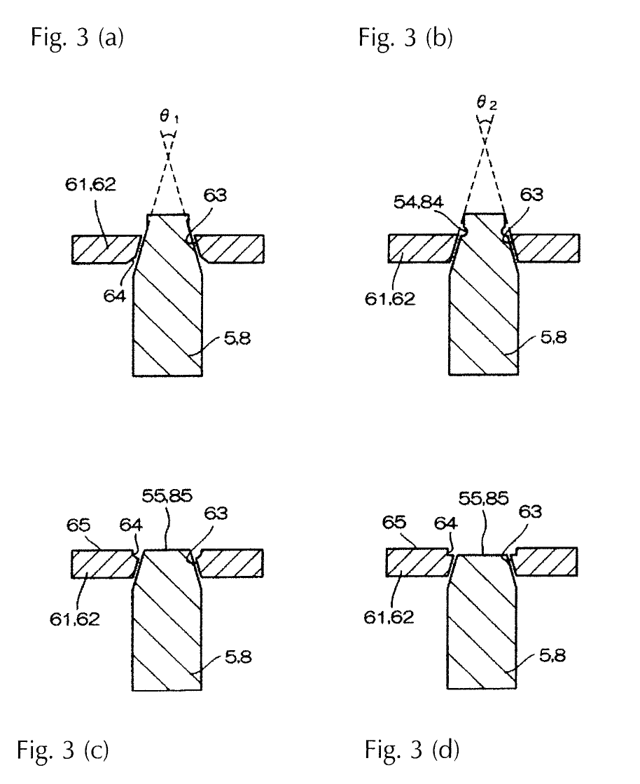

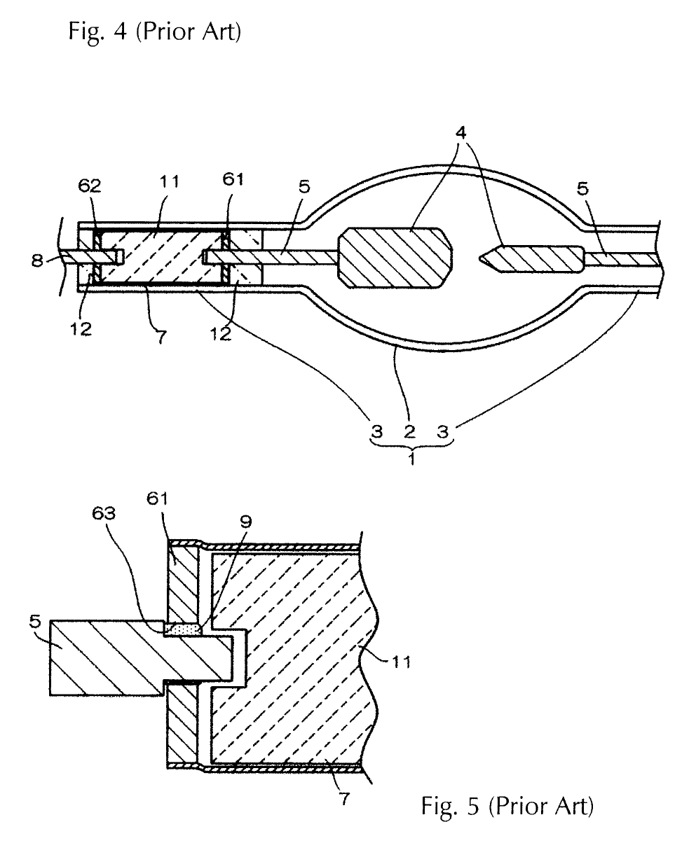

FIG. 3 shows sectional views explaining the shapes of the filler material reservoir section.

The discharge lamp having a filler material reservoir section as shown in this drawing has the same shape as that of the discharge lamp as shown in FIGS. 1 and 2 except for the shape of the filler material reservoir section. Any description and illustration is therefore omitted here except for the filler material reservoir section.

In the filler material reservoir section as shown in FIG. 3(a), the concavity 64 is formed on the other end surface of the through-hole 63 of the metal plate 61, 62 by widening this area, the other end surface having an opening of a larger diameter, thereby enlarging the gap between the metal plate 61, 62 and the electrode support rod 5. Thus, a filler material reservoir section can be provided by forming the concavity 64 on the other end surface of the metal plate 61, 62.

In the filler material reservoir section as shown in FIG. 3(b), a concavity 54, 84 is formed by making a dent on the lead 5, 8 rather than on the metal plate 61, 62, thereby enlarging the gap between the metal plate 61, 62 and the electrode support rod 5. Thus, a filler material reservoir section can be provided by forming the concavity 54, 84 on the lead 5, 8 rather than on the metal plate 61, 62.

In the filler material reservoir section as shown in FIG. 3(c), a concavity 64 is formed on one end surface of the metal plate 61, 62, the concave having a curved surface, thereby enlarging the gap between the metal plate 61, 62 and the electrode support rod 5. Thus, the shape of the concavity 64 is not limited to the tapered surface widened on the opening side of the through-hole 63; the surface may be curved. Furthermore, the end surface 55, 85 of the lead 5, 8 is formed in a manner of agreeing with the end surface 65 of the metal plate 61, 62.

In the filler material reservoir section as shown in FIG. 3(d), a concavity 64 is formed on one end surface of the metal plate 61, 62, the concave being cylindrical, thereby enlarging the gap between the metal plate 61, 62 and the electrode support rod 5. Thus, the shape of the concavity 64 may be varied as far as there is a space for storing material. Moreover, the end surface 55, 85 of the lead 5, 8 is positioned inwardly in the through-hole 63 away from the end surface 65 of the metal plate 61, 62, having the center of the metal plate 61, 62, with which the lead 5, 8 is joined, dented.

Next, a description of embodiments of the present invention is given below.

### Experimental Example 1

A metal plate having a tapered through-hole was joined together with a lead having a tapered section, whose outer periphery has a tapered surface, and the inclination of the metal plate and the deviation of the lead from the central axis were measured.

The following are the specifications of the metal plate and lead used for the experiment.

### (Specifications)

a. METAL PLATE: material: molybdenum, outer diameter: 26.5 mm, thickness in the axial direction: 4 mm, through-hole: 7.88 mm maximum diameter, 7.72 mm minimum diameter, 2.3° taper angle.

b. LEAD: material: tungsten, large diameter section: 137 mm length (in the axial direction), 7.72 mm outer diameter, small diameter section: 13 mm length (in the axial direction), 7.6 mm outer diameter, tapered section: 10 mm length (in the axial direction, 2.3° taper angle.

As shown in FIG. 3(a), the taper angle of the lead is represented by an angle of the cone point on the cut section formed by cutting the cone with a plane including its rotational axis, wherein the cone is formed by a virtual plane, the virtual plane being formed by extending the surfaces of the lead where the tapered section is formed.

As shown in FIG. 3(b), the taper angle of the metal plate is represented by an angle of the cone point on the cut section formed by cutting the cone with a plane including its rotational axis, wherein the cone is formed by a virtual plane, the virtual plane being formed by extending the inner surfaces of the tapered hole.

As for the inclination of the metal plate, the deflection of the disc surface of the metal plate was measured with a dial gauge by rotating it on its axis to find the inclination of the metal plate based on the distance between the central axis and a measured point. Thus, the angle of deviation was found. The deviation of the tip end of the lead is found by measuring the length of the deviation made by the tip end of the lead in the radial direction relative to an extended line of the central axis of the metal plate.

Three connected bodies were made by inserting a lead into a tapered through-hole to join them together, followed by bonding them using a filler material. Then the angle of deviation and the deviation on the tip end of the lead were measured.

As comparative embodiments, three connected bodies were also made by inserting a cylindrical lead into a cylindrical through-hole and bonding them using a filler material without joining them together. Then the angle of deviation and the deviation on the tip end of the lead were measured.

Table 1 shows the measured results.

TABLE 1

| | | Angle of | Deviation on tip |
|---|---|---|---|
| | | deviation | end of lead |
| | | (°) | (mm) |
| Present Invention | Connected Body 1 | 0.14 | 0.3 |
| | Connected Body 2 | 0.05 | 0.1 |
| | Connected Body 3 | 0.16 | 0.4 |
| Comparative | Connected Body 1 | 0.28 | 0.7 |
| Embodiments | Connected Body 2 | 0.34 | 0.8 |
| | Connected Body 3 | 0.40 | 1.0 |

Based on the measured results, it was confirmed that both the angle of deviation and the deviation on the tip end of the lead are smaller as a whole when the lead is inserted into a tapered through-hole to join them together, followed by bonding them using a filler material. Thus, it could be confirmed that the central axis of the metal plate can be matched to the central axis of the lead by joining them together on a tapered surface, followed by bonding them using a filler material.

### Experimental Example 2

The positional accuracy of attachment in the axial direction of a lead was measured after joining a metal plate having a tapered through-hole together with a lead having a tapered section, whose outer periphery has a tapered surface. Five cases were measured, wherein the taper angles were 0.5°, 1.0°, 1.5°, 2.0° and 2.5°.

The specifications are exactly the same as those for the metal plates and leads used in Experimental Example 1.

As for the positional accuracy of attachment, the distance between the tip end of the lead on the small diameter section and the surface of the metal plate on the side of the small diameter section was measured to find the deviation in the axial direction on the basis of the distance between the lead and the metal plate having standard central values.

Table 2 shows the measured results.

TABLE 2

| | Fitting Position Accuracy | |
|---|---|---|
| Taper Angle (°) | (mm) | Judgment |
| 0.5 | 4.6 | X |
| 1.0 | 2.3 | ◯ |
| 1.5 | 1.5 | ◯ |
| 2.0 | 1.1 | ◯ |
| 2.5 | 0.9 | ◯ |

The measured results show that the taper angle is preferably not less than 1.0°. The taper angle of 0.5° is not practical because the position of attachment deviates by as much as 4.6 mm in the axial direction of the lead. On the other hand, when the taper angle is 1.0°, the position of attachment deviates by 2.3 mm in the axial direction of the lead. However, this is a tolerable error for practical use in part because the outer lead connected to a stranded wire, which extends into the base member, can absorb deviation and in part because the electrode support rod can also absorb deviation by adjusting it at a time when the electrode is pressed into the tip end thereof.

### Experimental Example 3

It was checked if a metal plate can be fixed or not by joining the metal plate having a tapered through-hole together with a lead having a tapered section, whose outer periphery has a tapered surface.

Five cases were measured, wherein the taper angles were 28°, 29°, 30°, 31° and 32°.

The specifications are exactly the same as those for the metal plates and leads used in Experimental Example 1.

A connected body was used in which a metal plate and a lead are joined together yet before they are bonded together using a filler material in order to find if the metal plate can be fixed or not. This was judged based on whether the metal plate comes off or not by holding the lead in a manner of turning it upside down. When the metal plate did not come off, it was judged “a.” When the metal plate came off, it was judged “X.”

Table 3 shows the measured results.

TABLE 3

| Taper Angle (°) | Fixture of Metal Plate |
|---|---|
| 28 | ◯ |
| 29 | ◯ |
| 30 | ◯ |
| 31 | X |
| 32 | X |

The measured results show that the taper angle is preferably not more than 30°. When the taper angle is at most 30°, the metal plate is joined together with the lead to be fixed so well that the metal plate is hardly tilted when they are bonded using a filler material. Based on the results of Experimental Examples 2 and 3, it was concluded that the taper angle is preferably at least 1° and not more than 30°.

What is claimed is:

1. A discharge lamp comprising:
a discharge vessel having an arc tube and sealing tubes, the sealing tubes extending continuously from both ends of the arc tube in an outward direction;
a glass member disposed inside of at least one of the sealing tubes;
metal plates continuously disposed on the end surfaces of the glass member;
metal foils provided on the outer peripheral surface of the glass member and connected to the metal plates;
outer leads extending toward the outside of the discharge vessel; and
electrodes formed on tip ends of electrode leads extending toward the arc tube, the electrodes being disposed inside the arc tube in a manner of facing each other,
wherein at least one of the metal plates has a tapered through-hole;
wherein at least one of the leads is provided with a tapered section arranged in the tapered through-hole; and
wherein the tapered through-hole and the tapered section are joined together using a filler material.

2. The discharge lamp according to claim 1, wherein a concavity is formed on the through-hole of the metal plate by expanding one end face of the through-hole, the concavity providing a filler material reservoir section where a gap between the through-hole and the lead is widened.

3. The discharge lamp according to claim 1, wherein a concavity is formed by a dent on the lead, the concavity providing a filler material reservoir section.

4. The discharge lamp according to claim 1, wherein the taper angle of the through-hole of the metal plate is at least 1° and at most 30°.

5. The discharge lamp according to claim 1, wherein the taper angle of the tapered section of the lead is at least 1° and at most 30°.

6. The discharge lamp according to claim 5, wherein the taper angle of the tapered section of the lead and the taper angle of the through-hole of the metal plate correspond to each other.

7. The discharge lamp according to claim 1, wherein the glass member has a blind hole opposite the through-hole of the metal plate, with the outermost end of the lead protruding through the through-hole into said blind hole.

8. The discharge lamp according to claim 7, wherein the outermost end of the lead has a diameter which is at most the minimum diameter of the adjoining tapered section.

9. The discharge lamp according to claim 7, wherein the glass member has two blind holes on opposite faces thereof with respective outermost ends of an outer lead and an electrode lead inserted therein, said leads each protruding through a respective though-hole of a respective metal plate and being fixed to said metal plate using a filler material.
